(19) United States
(12) Patent Application Publication
(10) Pub. No.: US 2025/0031111 A1
(43) Pub. Date: Jan. 23, 2025

(54) METHOD AND SYSTEM FOR OFFSET-BASED MOBILITY PRIORITIZATION

(71) Applicant: Verizon Patent and Licensing Inc., Basking Ridge, NJ (US)

(72) Inventors: Viviana Rivera Torrico, Mission Viejo, CA (US); Jin Yang, Orinda, CA (US); Susan Wu Sanders, Bridgewater, NJ (US)

(21) Appl. No.: 18/354,695

(22) Filed: Jul. 19, 2023

(51) Int. Cl. H04W 36/00; H04W 36/30; H04W 72/56

(52) U.S. Cl. CPC H04W 36/00837; H04W 36/00835; H04W 36/0085; H04W 36/304; H04W 72/56

(57) ABSTRACT

A method, a network device, and a non-transitory computer-readable storage medium are described in relation to an offset-based mobility prioritization service. The offset-based mobility prioritization service may include obtaining performance metric information and any changes to configuration and/or topology of a transport network, such as an X-haul network. The offset-based mobility prioritization service may include calculating offset values, such as cell individual offset values, based on this information. The offset values may be calculated based on other factors, such as end device classifications, states and/or modes of end devices, and other information. The offset-based mobility prioritization service may further include calculating neighbor lists. The offset values and neighbor lists may be used to prioritize, influence, or steer end devices and/or source wireless stations in selecting target wireless stations when performing handover procedures or other types of cell selection or reselection procedures.

### BACKGROUND

Development and design of networks present certain challenges from a network-side perspective and an end device perspective. For example, Next Generation (NG) wireless networks, such as Fifth Generation New Radio (5G NR) networks are being deployed and are under development. End devices may connect to a radio access network according to various types of configurations and may be afforded different quality of service (QOS) levels.

### BRIEF DESCRIPTION OF THE DRAWINGS

FIG. 1 is a diagram illustrating an exemplary environment in which an exemplary embodiment of an offset-based mobility prioritization service may be implemented;

FIG. 2 is a diagram illustrating another exemplary environment in which an exemplary embodiment of the offset-based mobility prioritization service may be implemented;

FIGS. 3A-3F are diagrams illustrating an exemplary process of an exemplary embodiment of the offset-based mobility prioritization service according to an exemplary scenario;

FIG. 4 is a diagram illustrating exemplary components of a device that may correspond to one or more of the devices illustrated and described herein;

FIG. 5 is a flow diagram illustrating an exemplary process of an exemplary embodiment of the offset-based mobility prioritization service; and

FIG. 6 is a flow diagram illustrating another exemplary process of an exemplary embodiment of the offset-based mobility prioritization service.

### DETAILED DESCRIPTION

The following detailed description refers to the accompanying drawings. The same reference numbers in different drawings may identify the same or similar elements. Also, the following detailed description does not limit the invention.

End devices may be afforded different QoS levels based on their subscriptions, use of an application service, and other factors. A radio access network (RAN)'s connectivity to other networks, such as a transport network or an X-haul network (e.g., backhaul, fronthaul, mid-haul) may impact various performance metrics. For example, given the dynamism of the transport network, network paths, network routes, and/or network slices may experience fluctuations in terms of performance metrics (e.g., latency, throughput, reliability, packet error rate, etc.). However, wireless stations of the RAN may not have such information available, particularly as such information pertains to neighboring wireless stations. For example, a source RAN device (e.g., an evolved Node B (eNB), a next generation Node B (gNB) or the like) may be providing cellular service to an end device that, due to its mobility, will be subject to a handover procedure. As a consequence, the end device and/or the source RAN device may select a target RAN device, which may offer sub-optimal QoS to the end device, for the handover. According to another example, the end device may select a sub-optimal wireless station based on a cell selection or reselection procedure. In this regard, regardless of whether the end device is in idle or connected mode, the end device may be afforded sub-optimal QoS.

According to exemplary embodiments, an offset-based mobility prioritization service is described herein. The offset-based mobility prioritization service may be applied to a wireless environment. For example, the wireless environment may include a Fourth Generation (4G) wireless environment, a 5G wireless environment, and/or a future generation wireless environment, as described herein.

According to an exemplary embodiment, a radio access network (RAN) device may include logic of the offset-based mobility prioritization service, as described herein. For example, the RAN device may include a RAN intelligent controller (RIC) or similar type of RAN device (e.g., base station controller or the like), which may control or manage other RAN devices, such as an eNB, a gNB, a future generation wireless station, and/or the like.

According to an exemplary embodiment, the RAN device may obtain performance metric information pertaining to an X-haul network (e.g., backhaul, fronthaul, mid-haul) or similar type of transport network of the RAN. For example, the performance metric information may include performance metric parameters and, current and/or prospective/predictive performance metric values associated with the transport network and/or user plane traffic. By way of further example, the performance metric parameters may relate to latency, throughput, reliability, packet error rate, bit rate (e.g., maximum bit rate (MBR), minimum bit rate, guaranteed bit rate (GBR)), maximum data burst volume (MDBV), jitter, and/or similar types of information (e.g., key performance indicators (e.g., KPIs), 5G QoS Class Identifier (QCI) (also known as 5QI) values, 4G QCI, service level agreement (SLA) values, etc.). According to an exemplary embodiment, the RAN device may obtain other types of network information pertaining to the transport network, such as topology information, configuration information, and/or event information (e.g., changes to configuration and/or topology).

According to an exemplary embodiment, based on the performance metric information and other network information, the RAN device may calculate neighbor lists and offset values (e.g., cell individual offsets (CIOs)). According to an exemplary embodiment, the RAN device may calculate the offset values such that the degree of steering or influencing selection of a target wireless station (e.g., by an end device and/or source wireless station) may correspond to the performance metric value of a performance metric parameter, as described herein. For example, the lower the latency value associated with a target or neighbor wireless station and transport network communication link, the higher the priority of the target or neighbor wireless station may be afforded by way of the offset value. The offset values may include negative values, a zero value, or positive values (e.g., in dB). According to an exemplary embodiment, the RAN device may include machine learning and/or artificial intelligence (ML/AI) logic that calculates the offset values and/or the neighbor lists. The RAN device may also include logic that evaluates and prevent or minimizes conflict with other mobility/traffic steering algorithms, parameters related to mobility/traffic steering, and so forth.

According to some exemplary embodiments, the offset values may include offset values pertaining to when the end device is in an idle mode (e.g., Radio Resource Control (RRC) idle mode) and other offset values pertaining to when the end device is in a connected mode (e.g., RRC connected mode), as described herein. The offset values may pertain to other types of modes or states of end devices (e.g., RRC inactive, registered, de-registered, etc.). According to an exemplary embodiment, the RAN device may calculate different offset values based on different classifications of end devices. For example, there may be CIO values pertaining to end devices that have a sensitive performance metric requirement (e.g., low latency, high throughput, and/or another performance metric having a high measure of service) and other CIO values pertaining to end devices that do not have a sensitive performance metric requirement (e.g., average latency, high latency, average throughput, low throughput, etc.). According to some exemplary embodiments, the different end device classifications may correspond to different 5QI values. According to some exemplary embodiments, the RAN device may calculate different neighbor lists corresponding to the number of different performance metric-based classifications of the end devices (e.g., two, three, four, or higher number of classifications).

According to an exemplary embodiment, the RAN device may provide the neighbor lists and corresponding offset values to other RAN devices, as described herein. For example, the RAN device may directly or via an intermediary network device (e.g., element management system (EMS)) provide the neighbor lists and the offset values to wireless stations (e.g., eNBs, gNBs, future generation wireless stations, enhanced Long Term Evolution (eLTE) eNBs, and/or the like). The neighbor lists and the offset values may be vendor agnostic to accommodate the other RAN devices, as described herein, which may be associated with different vendors, configurations, etc.

According to an exemplary embodiment, the other RAN devices, such as the eNB, the gNB, the future generation wireless station, and/or the like may also include logic of the offset-based mobility prioritization service, as described herein. For example, the wireless station may store cell configuration management information that includes categorizations of the end devices and offset values. The wireless station may receive the neighbor lists and offset values from the RIC device and update the cell configuration management information.

According to an exemplary embodiment, the other RAN devices may communicate the offset values to the end devices of a particular categorization via an RRC message, as described herein. According to an exemplary embodiment, the other RAN device may determine to which category or classification the end device belongs and selects the corresponding or correlated offset values of the category or classification to transmit to the end device. According to various exemplary embodiments, the other RAN device may identify the classification of the end device based on an end device identifier (e.g., a subscription permanent identifier (SUPI), an international mobile subscriber identity (IMSI), or the like), and/or an end device group identifier (a network slice identifier (e.g., single-network slice selection assistance information (S-NSSAI), a service profile identifier (SPID), or the like). According to some exemplary embodiments, the other RAN devices may communicate the offset values to the end device as a part of a handover procedure. According to other exemplary embodiments, the other RAN device may communicate the offset values to the end device in relation to other types of cell selection procedures.

In view of the foregoing, the offset-based mobility prioritization service may improve a performance metric of traffic from the end device perspective and satisfy SLA requirements from the network perspective. The offset-based mobility prioritization service may improve mobility steering in the radio access network based on performance metric information associated with other networks.

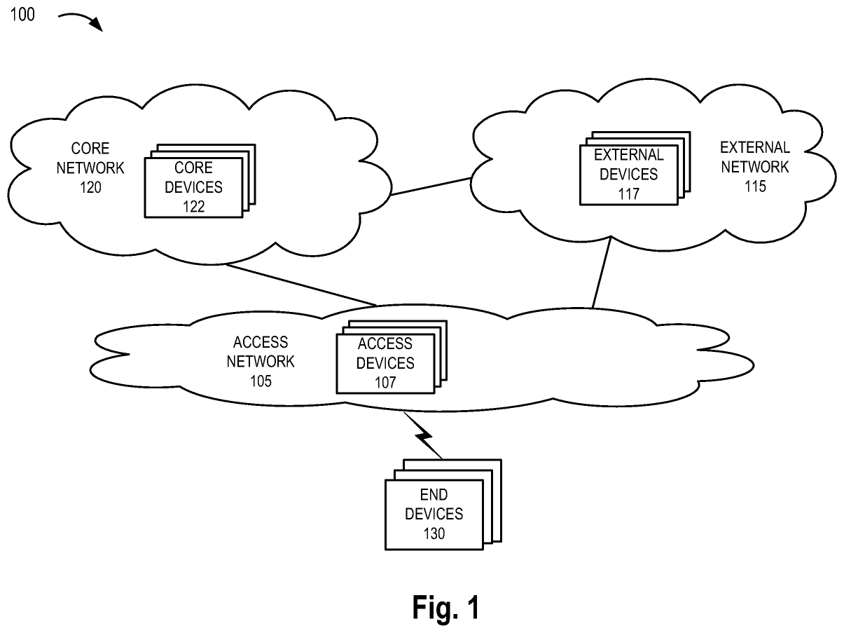

FIG. 1 is a diagram illustrating an exemplary environment 100 in which an exemplary embodiment of an offset-based mobility prioritization service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the offset-based mobility prioritization service may use at least one of these planes of communication.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a gNB, an eLTE eNB, an eNB, a radio network controller (RNC), a RIC, a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple radio access technologies (RATs) (e.g., 4G and 5G functionality, 5G and 5.5G functionality, etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to an exemplary embodiment, at least some of access devices 107 may include logic of an exemplary embodiment of the offset-based mobility prioritization service. For example, a RIC, an RNC, a BSC, or similar type of network device that may manage, control, and/or configure wireless stations of access network 107 (referred to herein simply as a RIC device) may provide the offset-based mobility prioritization service. According to an exemplary embodiment, the RIC device may calculate neighbor lists and offset values based on the performance metric information pertaining to a transport or X-haul network of relevance, as described herein. For example, the performance metric information may include performance metric parameters and, current and/or prospective/predictive performance metric values associated with the transport network and/or user plane traffic. By way of further example, the performance metric parameters may relate to latency, throughput, reliability, packet error rate, bit rate, jitter, and/or similar types of information, such as KPIs, 5G QCIs, 4G QCIs, SLAs, and the like. According to an exemplary embodiment, the RIC device may obtain other types of network information pertaining to the transport network, such as topology information, configuration information, and/or event information (e.g., a change to a configuration of a transport device, a change to a topology of the transport network (e.g., new transport devices added, existing transport device remove, changing connections associated with communication links, network routes or paths, or the like). According to some exemplary embodiment, the RIC device may obtain the performance metric information and other types of network information pertaining to the transport network, as described herein, from a network management device or similar network device that may monitor network devices, communication links, user plane traffic, end devices 130, and/or the like.

According to an exemplary embodiment, the RIC device may calculate the neighbor lists and/or the offset values based on an ML/AI component. According to an exemplary embodiment, the ML/AI component may include logic that creates, trains, re-trains, tunes, and/or updates a model (e.g., an AI model, an ML model, a learning-based model, a custom model, a prediction model, etc.) using the performance metric information (e.g., historical, current, prospective, etc.), other network information, an ML algorithm, an AI algorithm, a deep learning algorithm, or another type of learning algorithm, as described herein. According to various exemplary implementations, the learning algorithm may include a supervised learning algorithm, an unsupervised learning algorithm, and/or a reinforcement learning algorithm. The ML/AI component may include logic that includes predictive analytics. For example, the ML/AI component may include a model that may be implemented as a Support Vector Machine, a Decision Tree, a Neural Network, Naïve Bayes, Random Forest, another type of learning-based algorithm, and/or a non-learning-based algorithm/rule-based logic.

According to an exemplary embodiment, at least some other access devices 107 may include logic of an exemplary embodiment of the offset-based mobility prioritization service. For example, a gNB, an eNB, an eLTE eNB, or another type of cellular wireless station of access network 105 (referred to simply as wireless station) may provide the offset-based mobility prioritization service. The wireless station may communicate the offset values to end devices 130 of a particular categorization via an RRC message, as described herein. The wireless station may determine to which category or classification end device 130 belongs and selects the corresponding or correlated offset values of the category or classification to transmit to end device 130. The wireless station may identify the classification of end device 130 based on an end device identifier and/or an end device group identifier. The wireless station may communicate the offset values to end device 130 as a part of a handover procedure (e.g., network initiated, end device initiated, intra-frequency handover, intra-frequency handover, etc.) or another type of a procedure that may include a cell selection or reselection procedure.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a MEC network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a network exposure function (NEF), a service capability exposure function (SCEF), a lifecycle management (LCM) device, a mobility management entity (MME), a packet data network gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., other type of user equipment (UE)). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

End device 130 may include logic of an exemplary embodiment of the offset-based mobility prioritization service. For example, end device 130 may receive offset values from access device 107 (e.g., wireless station) and apply the offset values to cell measurement values of wireless stations. For example, end device 130 may apply an offset value to a measured reference signal received power (RSRP) value pertaining to a candidate wireless station. End device 130 may generate a measurement report and transmit the measurement report to a source wireless station. End device 130 may receive from the source wireless station a handover command, which may include RRC connection reconfiguration information and a target wireless station, for example.

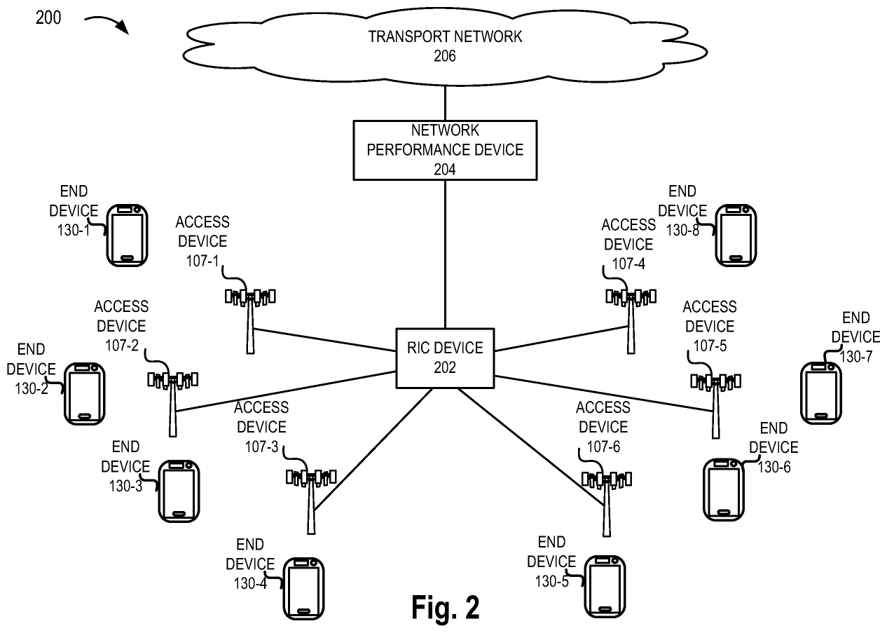

FIG. 2 is a diagram illustrating another exemplary environment in which an exemplary embodiment of the offset-based mobility prioritization service may be implemented. As illustrated, exemplary environment 200 may include a RIC device 202, a network performance device 204, a transport network 206, access devices 107-1 through 107-6, and end devices 130-1 through 130-8. Access device 107 and end device 130 have already been described. Access device 107 may be implemented as a cellular wireless station, such as an eNB, a gNB, an eLTE eNB, and the like, as previously described.

RIC device 202 may provide intelligent radio resource management, QoS management, connectivity management, and handover management in a RAN. For example, RIC device 202 may control and optimize various radio resources, such as the selection of radio access devices (e.g., eNB, CU, gNB), etc.) associated with a 4G, 5G, or future RAN. RIC device 202 may support real-time intelligent radio resource management. For example, RIC device 202 may control and optimize various radio resources of radio access devices (e.g., eNB, RU, RRH, gNB, DU, etc.) associated with a 4G, 5G, or future RAN, radio resource scheduling for uplink and downlink communication with end device 130, and radio signal characteristics (e.g., modulation, beam management, etc.). RIC device 202 may support non-real-time intelligent radio resource management, higher layer procedure optimization, and policy optimization in a RAN. According to an exemplary embodiment, RIC device 202 may include logic of an exemplary embodiment of the offset-based mobility prioritization service, as described herein.

Network performance device 204 may include a network device that monitors, collects, obtains, and/or evaluates network information pertaining to transport network 206. For example, the network information may include performance metric parameters and values relating to network devices, communication links, network paths, and/or other types of network infrastructure associated with transport network 206, user plane traffic, network slices, and other types of resource that may support a network service and/or an application service, as described herein. According to an exemplary embodiment, network performance device 204 may obtain network information (e.g., analytics information, performance metric information, etc.) from an NWDAF. According to other exemplary embodiments, network performance device 204 may obtain network information from another type of device that may provide real-time analytics data (e.g., a SON device). According to some exemplary embodiments, network performance device 204 may obtain network information from access device 107, core device 122, and/or external device 117. Network performance device 204 may collect data, which may be statistical or real-time streaming from various devices, such as the NWDAF, a SON, or another type of network device.

According to various exemplary embodiments, the performance metric parameters and values may include KPIs, QoS parameters and values, Quality of Experience (QoE) parameters and values, SLA parameters and values, Mean Opinion Score (MOS) parameters and values, data volume (e.g., maximum, minimum, etc.), latency, packet error, delay, bit rates (e.g., guaranteed, maximum, minimum, burst, etc.), jitter, retries, 5G QCIs and characteristics, and so forth. A performance metric value may be implemented as a single value (e.g., X) or a range of values (e.g., X to Y). The performance metric value may also be associated with a time period (e.g., seconds, hour(s), day(s), and/or another time period), may indicate an average value, a mean value, and/or another statistical value. By way of further example, the performance metric information may relate to the performance associated with user sessions, connections, channels, messaging, a network procedure (e.g., attachment, handover, session establishment, local breakout, dual connectivity, etc.), application services, and/or other types of metrics in relation to transport network 206. The performance metric information may relate to user plane or user plane and control plane events or metrics. As an example, the performance metric information may include information relating to Radio Resource Control (RRC) setup failures, handover attempts, handover failures, radio bearer drops, uplink and/or downlink throughput, voice call drops, random access failures,

Transport network 206 may include an X-haul network, a signaling network, and/or another type of intermediary network relative to access network 105. For example, access network 105 may communicate to core network 120 via transport network 206. Although not illustrated, transport network 206 may connect to access devices 107/access network 105. For example, transport network 206 may communicatively couple access devices 107 to another network, such as core network 120, external network 115, and so forth. Transport network 206 may include wired, wireless, and/or optical communication links, routing devices, switches, relay devices, aggregation points, and/or other types of back/mid/front-haul types of devices.

Environment 200 is exemplary and according to other embodiments, environment 200 may include additional and/or fewer network devices. For example, although not illustrated, there may be an intermediary network device (e.g., an EMS) between RIC device 202 and access device 107, as previously described herein.

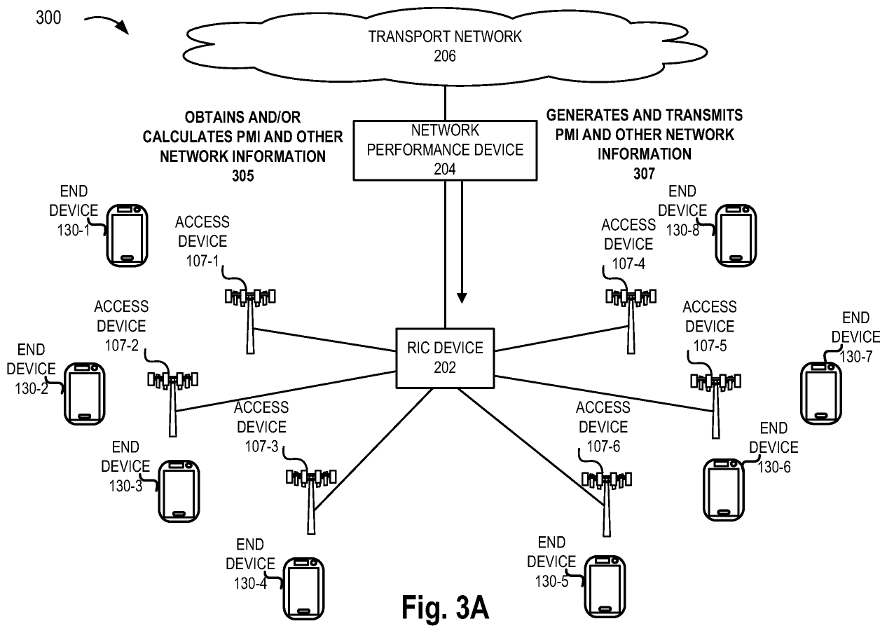

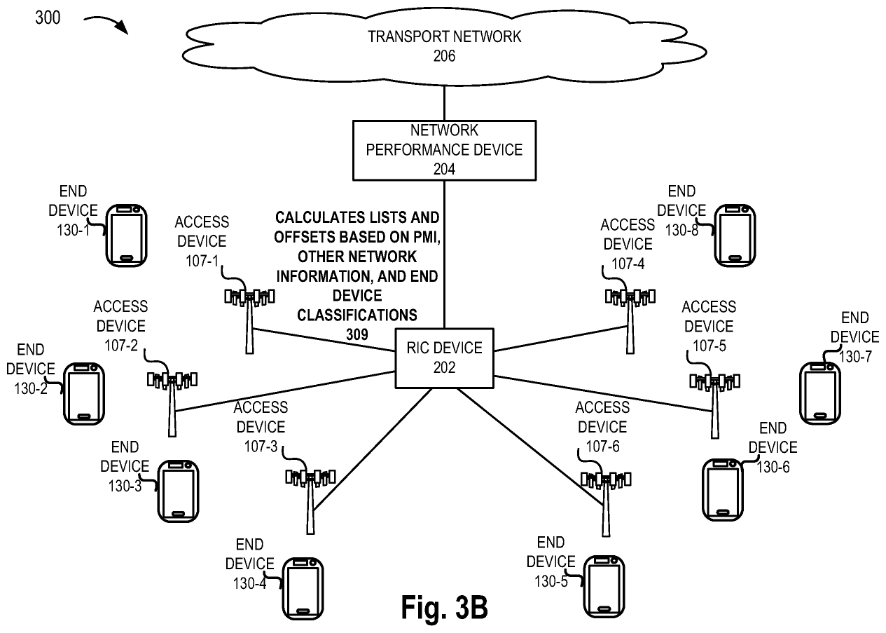

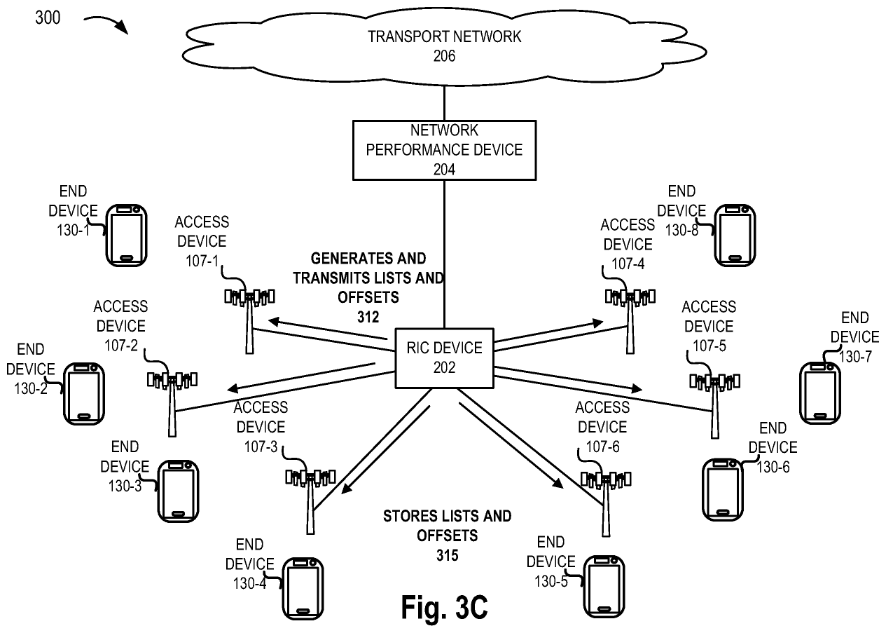

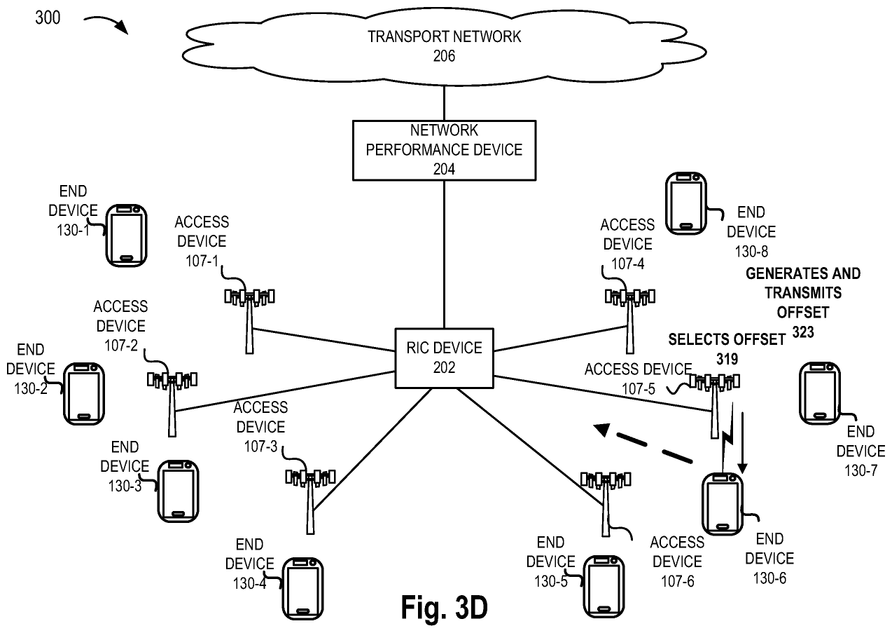

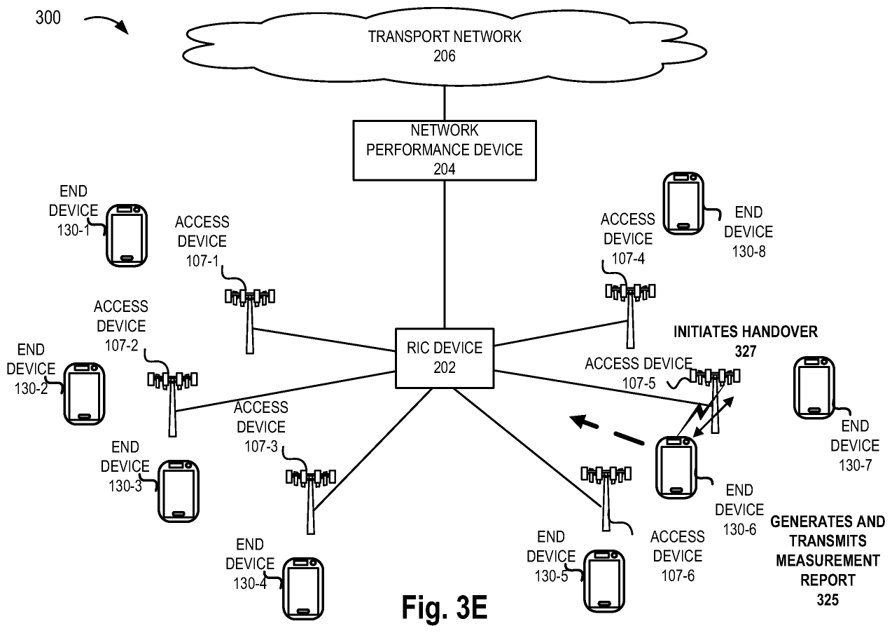

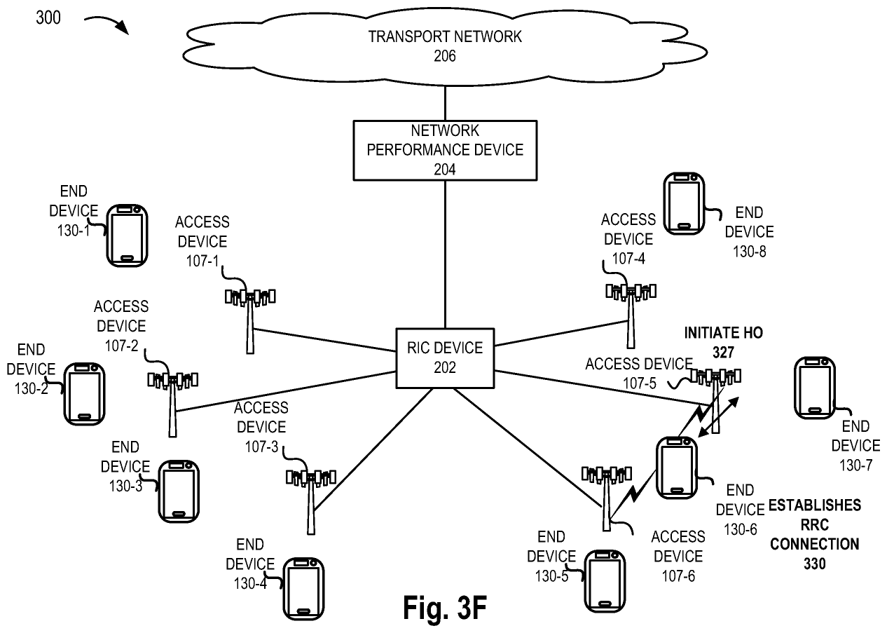

FIGS. 3A-3F are diagrams illustrating an exemplary process 300 of an exemplary embodiment of the offset-based mobility prioritization service according to an exemplary scenario. For purposes of description, process 300 is described in relation to environment 200.

Referring to FIG. 3A, network performance device 204 may obtain and/or calculate performance metric information (PMI) and other network information 305. For example, the other network information may include event information (e.g., changes to topology and/or configuration information of transport network 206). It may be assumed that network performance device 204 may store topology and configuration information pertaining to transport network 206. Network performance device 204 may generate and transmit the PMI and other network information 307 to RIC device 202. According to some exemplary embodiments, network performance device 204 may select a portion of the PMI and other network information that is of relevance to RIC device 202 and access devices 107 that are under the control of or managed by RIC device 202 based on topology information of transport network 206 relative to access devices 107.

Referring to FIG. 3B, in response to receiving the PMI and other network information, RIC device 202 may calculate neighbor lists and offsets based on the PMI, other network information, and end device classifications 309. For example, the ML/AI logic of RIC device 202 may calculate offset values and neighbor lists for each of access devices 107-1 through 107-6. According to some exemplary embodiments, the offset values may correlate to different end device states (e.g., RRC idle, RRC connected, and other states/modes), as described herein. The offset values may further correlate to different classifications or groups of end devices 130, as described herein. According to some exemplary embodiments, the offset values may be correlated to and/or assigned a time period of validity (e.g., time-to-live (TTL)). According to an exemplary implementation, the offset values may be implemented as CIO values. An offset value may have a unit of measurement in dB, for example.

According to some exemplary embodiments, the ML/AI logic of RIC device 202 may calculate the offset values such that the degree of steering or influencing selection of a target or neighbor wireless station (e.g., by end device 130 and/or a source access device 107) may correspond to the performance metric value of the performance metric parameter, as described herein. For example, the higher the throughput value associated with a target or neighbor wireless station and transport network communication link, the higher the priority of the target or neighbor wireless station may be afforded by way of the offset value. The offset value may further be calculated in view of other mobility parameters, such as mobility load balancing (MLB), mobility robustness optimization (MRO), automatic neighbor relation (ANR), and/or other types of parameters that may improve overall KPIs and/or the like.

According to an exemplary implementation, the ML/AI logic of RIC device 202 may calculate different neighbor lists corresponding to the number of different performance metric-based classifications of end devices 130 (e.g., two, three, four, or higher number of classifications) for each source access device 107. By way of further example, if there are two classifications of end devices 130, such as a performance metric sensitive classification and a non-performance metric sensitive classification, the ML/AI logic may generate a neighbors list for each classification of end device 130 and source access device 107. Referring to FIG. 3C, subsequent to the calculation procedure, RIC device 202 may generate and transmit the neighbor lists and offsets 312 to each access device 107. In response to receiving the neighbor lists and offsets, each access device 107 may store the neighbors lists and offsets 315.

Referring to FIG. 3D, according to an exemplary scenario, assume that access device 107-5 is a source access device for end device 130-6, and end device 130-6 is in an RRC connected state. Based on receiving the neighbor lists and PMI, access device 107-5 may select an offset 319 (e.g., based on the state and classification of end device 130), and may generate and transmit the offset 323 to end device 130-6. For example, access device 107-5 may transmit an RRC message, which includes the offset values, to end device 130-5. Referring to FIG. 3E, end device 130-6 may perform a cell search and generate and transmit a measurement report 325 to access device 107-5. The measured values may be modified by end device 130 according to their corresponding offset values and associated cells. Referring to FIG. 3F, based on the receipt of the measurement report, access device 107-5 may initiate a handover 327. For example, access device 107-5 may select a target access device (e.g., access device 107-6) based on the measurement report and associated neighbors list for the handover. Access device 107-5 may generate and transmit reconfiguration and target cell information in an RRC connection re-configuration message to end device 130-6. In response to receipt of the RRC message, end device 130-6 may establish an RRC connection 330 with access device 107-6.

FIGS. 3A-3F illustrate process 300 according to an exemplary scenario, however according to other exemplary scenarios and/or embodiments, process 300 may include additional, different, and/or fewer steps or operations pertaining to the offset-based mobility prioritization service, as described herein. For example, for an end device initiated handover, end device 130-6 may receive an RRC connection reconfiguration message from access device 107-5 that may include one or multiple candidate or target access devices 107 from which end device 130-6 may select for completion of the handover. According to yet other exemplary embodiments, access device 107 may provide offsets to end device 130 as a part of an RRC connection setup procedure. For example, access device 107 may include offsets in an RRC connection setup message or an RRC connection reconfiguration message. According to another exemplary scenario, assume access device 107-4 and access device 107-6 cover the same geographic area. Access device 107-4 may operate in a different frequency band than access device 107-6. For example, access device 107-4 may provide a 5G NR frequency band n5 and access device 107-6 may provide a 5G NR frequency n77. Access device 107-4 may have a long backhaul latency and access device 107-6 may have a short backhaul latency. Referring to FIG. 3F, for example, end device 130-6 may be connected to access device 107-5. Access device 107-5 may instruct end device 130-6 for neighbor cell measurement via an RRC reconfiguration message. In this message, neighbor cell access device 107-4 may have a lower CIO to make handover more difficult (or less likely) while neighbor cell access device 107-6 may have a higher CIO to make handover easier (or more likely).

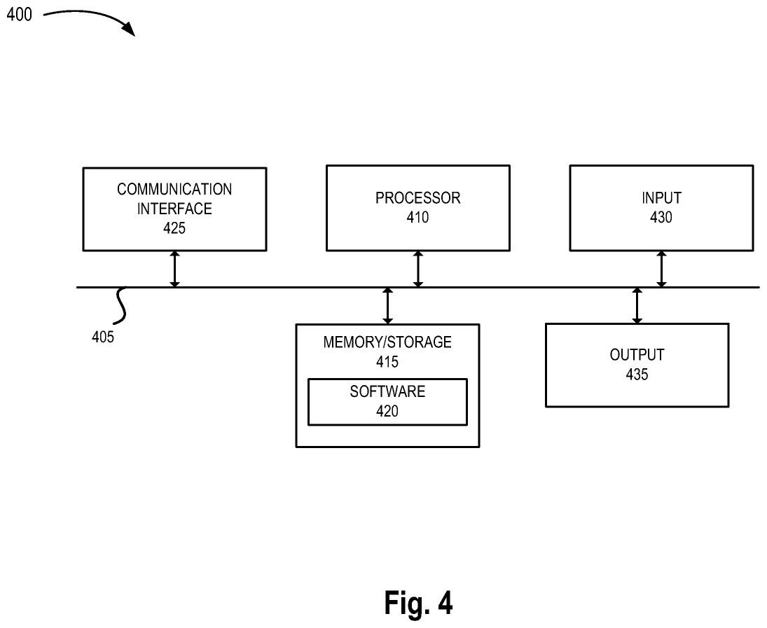

FIG. 4 is a diagram illustrating exemplary components of a device 400 that may be included in one or more of the devices described herein. For example, device 400 may correspond to access device 107, external device 117, core device 122, end device 130, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUS), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to access device 107, software 420 may include an application that, when executed by processor 410, provides a function and/or a process of the offset-based mobility prioritization service, as described herein. Software 420 may also include firmware, middleware, microcode, hardware description language (HDL), and/or another form of instruction. Software 420 may also be virtualized. Software 420 may further include an operating system (OS) (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard. Communication interface 425 may support one or multiple MIMO, beamforming, and/or transmission/reception configurations.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a function or a process described herein. Alternatively, for example, according to other implementations, device 400 may be configured to perform a function or a process described herein based on the execution of hardware (processor 410, etc.).

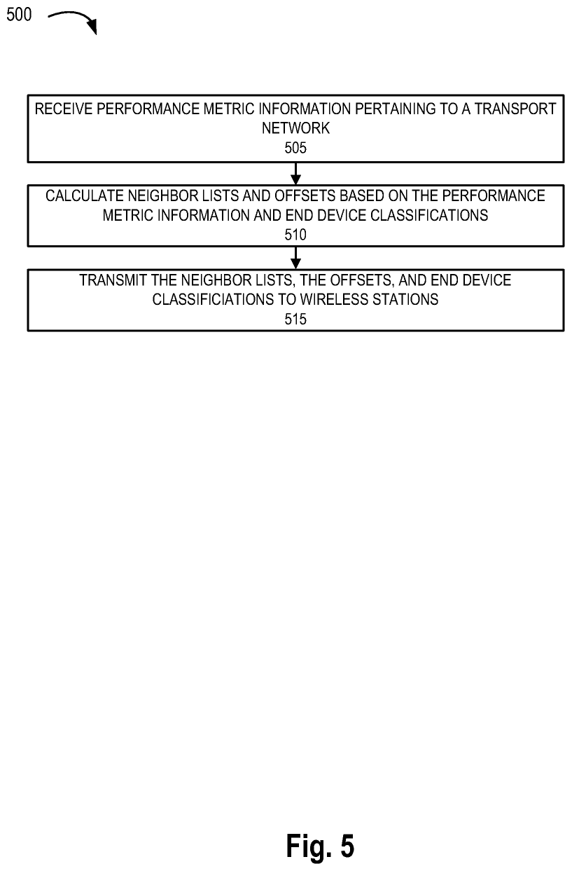

FIG. 5 is a flow diagram illustrating an exemplary process 500 of an exemplary embodiment of the offset-based mobility prioritization service. According to an exemplary embodiment, access device 107 may perform process 500. As described herein, access device 107 may be implemented as a RIC device, such as RIC device 202 or similar RAN controller device. According to an exemplary implementation, processor 410 executes software 420 to perform a step (in whole or in part) of process 500, as described herein. Alternatively, a step (in whole or in part) may be performed by execution of only hardware.

Referring to FIG. 5, in block 505, RIC device 202 may receive performance metric information pertaining to a transport network, such as transport network 206. For example, RIC device 202 may receive performance metric information and other network information (e.g., changes to configuration and/or topology of transport network 206), as described herein, from network performance device 204.

In block 510, RIC device 202 may calculate neighbor lists and offsets based on the performance metric information and end device classification. For example, RIC device 202 may calculate the neighbor lists and offset values based on the performance metric information, different end device classifications (e.g., different 5QCI values or other types of categories as described herein), state and/or mode of end devices 130, and other factors, as described herein. The offset value information may include a CIO value, a state and/or mode of end device 130, a classification of end device 130, a time period, a QoS identifier (e.g., 5QCI or the like), and/or other correlated information, as described herein. The offset value information may indicate a target access device, a radio frequency, a carrier frequency, and/or the like.

In block 510, RIC device 202 may transmit the neighbor lists, the offset values, and end device classifications to wireless stations. For example, RIC device 202 may transmit the offset information and neighbor lists to access devices 107 managed by RIC device 202.

FIG. 5 illustrates an exemplary process 500 of the offset-based mobility prioritization service, however, according to other exemplary embodiments, the offset-based mobility prioritization service may perform additional operations, fewer operations, and/or different operations than those illustrated and described in relation to FIG. 5. For example, RIC device 202 may perform additional and/or different operations or steps as described elsewhere in this description.

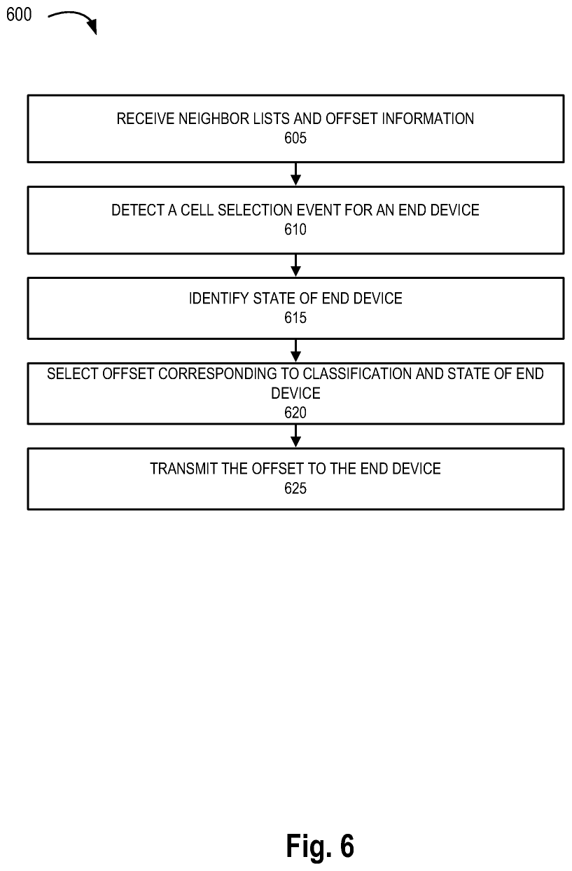

FIG. 6 is a flow diagram illustrating an exemplary process 600 of an exemplary embodiment of the offset-based mobility prioritization service. According to an exemplary embodiment, access device 107 may perform process 600. For example, access device 107 may be implemented as a cellular wireless station, such as an eNB, an eLTE eNB, a gNB, or the like. According to an exemplary implementation, processor 410 executes software 420 to perform a step (in whole or in part) of process 600, as described herein. Alternatively, a step (in whole or in part) may be performed by execution of only hardware.

Referring to FIG. 6, in block 605, access device 107 may receive neighbor lists and offset information. For example, the cellular wireless station may receive, from RIC device 202, neighbor lists and offset information, as described herein. The offset information may include CIO values, end device classifications, end device states and/or modes, and other correlated information (e.g., TTL, etc.), for example, as described herein.

In block 610, access device 107 may detect a cell selection event for end device 130. For example, the cellular wireless station may determine to invoke a handover procedure or receive a message indicating of invoking a handover procedure or another type of procedure that may include a cell selection or reselection.

In block 615, access device 107 may identify a state of end device 130. In block 620, access device 107 may select an offset corresponding the classification and state of end device 130. In block 625, access device 107 may transmit the offset to end device 130. For example, the cellular wireless station may transmit the offset to end device 130 via an RRC message, as described herein.

FIG. 6 illustrates an exemplary process of the offset-based mobility prioritization service, however, according to other exemplary embodiments, the offset-based mobility prioritization service may perform additional operations, fewer operations, and/or different operations than those illustrated and described in relation to FIG. 6. For example, access device 107 may perform additional and/or different operations as described elsewhere in this description.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks have been described regarding the processes illustrated in FIGS. 5 and 6, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a radio access network (RAN) controller device of a RAN, performance metric information pertaining to a transport network connected to the RAN;
calculating, by the RAN controller device, offset values based on the performance metric information and different performance metric classifications of end devices; and
transmitting, by the RAN controller device, the offset values to wireless stations of the RAN.

2. The method of claim 1, wherein the performance metric information includes performance metric values relating to at least one of latency, throughput, reliability, or packet error pertaining to the transport network, and wherein the transport network includes an X-haul network.

3. The method of claim 1, further comprising:
calculating, by the RAN controller device, neighbor lists for each wireless station of the wireless stations based on the performance metric information and different performance metric classifications of the end devices.

4. The method of claim 1, further comprising:
receiving, by the RAN controller device, at least one of configuration or topology change information of the transport network, and wherein the calculating further comprises:
calculating, by the RAN controller device, the offset values based on the performance metric information, the different performance metric classifications of end devices, and the at least one of the configuration or topology change information.

5. The method of claim 1, further comprising:
calculating, by the RAN controller device, the offset values based on the performance metric information, the different performance metric classifications of end devices, at least one of configuration or topology change information, and at least one of mobility load balancing (MLB), mobility robustness optimization (MRO), or automatic neighbor relation (ANR).

6. The method of claim 1, wherein the different performance metric classifications relate to different Fifth Generation (5G) Quality of Service Class Identifiers (5QCIs).

7. The method of claim 1, wherein the offset values include cell individual offset values that pertain to different radio resource control (RRC) states of the end devices.

8. The method of claim 1, wherein the RAN controller device includes a RAN intelligent controller (RIC) device or a base station controller (BSC) device.

9. A network device comprising:
a processor that is configured to:
receive performance metric information pertaining to a transport network connected to a radio access network (RAN), wherein the network device is a RAN controller device of the RAN;
calculate offset values based on the performance metric information and different performance metric classifications of end devices; and
transmit the offset values to wireless stations of the RAN.

10. The network device of claim 9, wherein the performance metric information includes performance metric values relating to at least one of latency, throughput, reliability, or packet error pertaining to the transport network, and wherein the transport network includes an X-haul network.

11. The network device of claim 9, wherein the processor is further configured to:
calculate neighbor lists for each wireless station of the wireless stations based on the performance metric information and different performance metric classifications of the end devices.

12. The network device of claim 9, wherein the processor is further configured to:
receive at least one of configuration or topology change information of the transport network, and wherein the processor is further configured for calculating to:
calculate the offset values based on the performance metric information, the different performance metric classifications of end devices, and the at least one of the configuration or topology change information.

13. The network device of claim 9, wherein the processor is further configured for calculating to:
calculate the offset values based on the performance metric information, the different performance metric classifications of end devices, at least one of configuration or topology change information, and at least one of mobility load balancing (MLB), mobility robustness optimization (MRO), or automatic neighbor relation (ANR).

14. The network device of claim 9, wherein the different performance metric classifications relate to different Fifth Generation (5G) Quality of Service Class Identifiers (5QCIs).

15. The network device of claim 9, wherein the offset values include cell individual offset values that pertain to different radio resource control (RRC) states of the end devices.

16. The network device of claim 9, wherein the RAN controller device includes a RAN intelligent controller (RIC) device or a base station controller (BSC) device.

17. A non-transitory computer-readable storage medium storing instructions executable by a processor of a radio access network (RAN) controller device, wherein the instructions are configured to:
receive performance metric information pertaining to a transport network connected to a radio access network (RAN);
calculate offset values based on the performance metric information and different performance metric classifications of end devices; and
transmit the offset values to wireless stations of the RAN.

18. The non-transitory computer-readable storage medium of claim 17, wherein the instructions are further configured to:
calculate the offset values based on the performance metric information, the different performance metric classifications of end devices, at least one of configuration or topology change information, and at least one of mobility load balancing (MLB), mobility robustness optimization (MRO), or automatic neighbor relation (ANR).

19. The non-transitory computer-readable storage medium of claim 17, wherein the different performance metric classifications relate to different Fifth Generation (5G) Quality of Service Class Identifiers (5QCIs).

20. The non-transitory computer-readable storage medium of claim 17, wherein the offset values include cell individual offset values that pertain to different radio resource control (RRC) states of the end devices.
